(19) United States
(12) Patent Application Publication
(10) Pub. No.: US 2015/0246653 A1
(43) Pub. Date: Sep. 3, 2015

(54) ORGANOSHEET AS A DISTANCE KEEPER IN IMPACT BEAM

(71) Applicant: NV BEKAERT SA, Zwevegem (BE)

(72) Inventor: Veerle Van Wassenhove, Aarsele (BE)

(73) Assignee: NV BEKAERT SA, Zwevegem (BE)

(21) Appl. No.: 14/428,620

(22) PCT Filed: Sep. 17, 2013
(86) PCT No.: PCT/EP2013/069195

§ 371 Date: Mar. 16, 2015

(30) Foreign Application Priority Data
Sep. 18, 2012 (EP) 12184843.6

(51) Int. Cl. B60R 19/03; B29C 45/14; B62D 25/04

(52) U.S. Cl. CPC B60R 19/03; B62D 25/04; B29C 45/14631; B29K 2105/0809

(57) ABSTRACT

An impact beam comprises a polymer matrix and a reinforcing fabric, and further comprises at least one layer of polymer material, especially continuous fibre reinforced material (organosheet or uni directional tape or laminate) being positioned between the reinforcing fabric and the exterior surface of the impact beam in order to keep the reinforcing fabric away from the exterior surface of the impact beam.

### TECHNICAL FIELD

The present invention relates to impact beams and reinforcements. The invention also relates to methods for providing such impact beams. The invention further relates to the use of impact beams bumpers of vehicles or for impact reinforcement of parts of vehicles.

### BACKGROUND ART

Impact beams are for instance known made of a polymer matrix which is reinforced with glass fibres or other polymer fibres. An impact beam may also comprise metal parts, usually on the places where the impact beam receives high load during impact.

In U.S. Pat. No. 5,290,079, the impact beam comprises a woven wire mesh within the matrix, which is to improve the ductility and flexibility of the impact beam. Besides, US 2006/013990 also discloses an impact beam with a polymer matrix and a textile product comprising metal cords which are preferably stitched to the separate textile layer. Such an impact beam reduces or solves the problem of migration of the cords during pressing.

Impact beams may be made by pressure moulding or by injection moulding. Due to these manufacturing techniques, these known impact beams have the drawback however that metal parts tend to be present at the exterior surface of the matrix which will result in corrosion risk and reinforcement which is situated too much at the surface. Indeed it is quite possible that the polymer matrix material fails to surround all the metal reinforcing parts because of too exterior placement or much possibility that the metal reinforcing parts are just lying at the exterior surface of the matrix. Thus most part of the wire mesh or metal reinforcing cords will be exposed to the air during a long time, which will take a high risk at corrosion.

### DISCLOSURE OF INVENTION

It is an object of the invention to provide an improved impact beam wherein at least one of the above stated prior art drawbacks is obviated.

It is also an object of the present invention to provide one kind of ‘distance keeper’ for impact beam that keeps the reinforcing fabric in the impact beam away from the exterior surface of the impact beam. The wording “exterior surface” is to be understood in a sense that the surface of the impact beam which is at least partly exposed to the air directly.

It is a further object of the invention to provide a method for manufacturing an impact beam provided with such a kind of ‘distance keeper’.

According a first aspect of the present invention, there is provided for this purpose an impact beam for a vehicle, wherein the impact beam comprises a polymer matrix and a reinforcing fabric, and further comprises at least one layer of continuous fibre reinforced material (organosheet or uni directional tape or laminate) being positioned between the reinforcing fabric and the exterior surface of the impact beam in order to keep the reinforcing fabric away from the exterior surface of the impact beam. The layer of organosheet here in the impact beam works as a kind of ‘distance keeper’ according to the invention, which keeps the reinforcing fabric away from the exterior surface of the impact beam in order to avoid that the reinforcing fabric is exposed directly to the air and in order to position the reinforcing fabric more in the middle of the matrix. Additional layers of continuous fibre reinforced material (organosheet or uni directional tape or laminate) can be placed at any location in the structure. The fibre contents of these ‘distance keepers’ layers may vary between 0 vol% up to 80 vol% fibre contents.

In one preferable embodiment, the impact beam comprises only one layer of continuous fibre reinforced material (organosheet or uni directional tape or laminate) being positioned between the fabric and the exterior surface of the impact beam.

In another preferable embodiment, the impact beam further comprises at least one layer of continuous fibre reinforced material (organosheet or uni directional tape or laminate) being positioned between the fabric and the inner surface of the impact beam. The wording “inner surface” is to be understood in a sense that the surface of the impact beam which is near the injection point while the exterior surface is positioned away from the injection point.

According to a preferred embodiment, the impact beam comprises a first layer and a second layer of organosheet, the first layer of continuous fibre reinforced material (organosheet or uni directional tape or laminate) being positioned between the fabric and the inner surface of the impact beam and the second layer of continuous fibre reinforced material (organosheet or uni directional tape or laminate) being positioned between the fabric and the exterior surface of the impact beam. The first layer of continuous fibre reinforced material (organosheet or uni directional tape or laminate) may be the same as or different from the second one.

Preferably, the layer of continuous fibre reinforced material (organosheet or uni directional tape or laminate) according to the invention comprises a polymer matrix sheet. This polymer matrix is preferably a thermoplastic polymer material.

The thermoplastic polymer material is selected from the group consisting of polypropylene, polyethylene, polyamide, polyethylene terephtalate, polybutylene terephtalate, polycarbonate, polyphenylene oxide as well as blends of these materials, or thermoplastic elastomers, e.g. polyamide- or polyolefin- based thermoplastic elastomers such as polyester amides, polyether ester amides, polycarbonate-ester amides or polyether-block-amides.

More preferably, the sheet is made out of polyamide- or polyolefin-based thermoplastic elastomers.

More preferably, the polymer matrix sheet further comprises glass- or C-fibers, polymeric fibers and/or mineral fillers. Fibers can either be random, unidirectional, woven; stitched, chopped, or a combination of those.

Preferably, the reinforcing fabric in the impact beam according to the invention is provided out of steel alloy, e.g. low carbon steel, high carbon steel.

More preferably, the metal reinforcing fabric is a woven, braided knitted, welded or laminated structure.

Preferably, the impact beam may comprise several of layers of organosheet being positioned between the reinforcing fabric and the exterior surface of the impact beam according to the invention, and said layers are essentially parallel to each other. The layer which is the closest to the exterior surface of the impact beam acts as a ‘distance keeper’ while the other layers function as further reinforcing elements in the impact beam. These layers of organosheet may be the same or different from each other.

According to a second aspect of the present invention, there is provided a method for manufacturing an impact beam for a vehicle, the method comprises the steps of:
manufacturing a reinforcing fabric;
manufacturing one or more layers of organosheet;
placing the reinforcing fabric with the one or more layers of
continuous fibre reinforced material (organosheet or uni directional tape or laminate) (that are when applicable preformed (and heated) into an injection mold;
injecting polymer material to the whole of above for bringing thereof into the desired form;
cooling the impact beam.

An impact beam according to the invention may be used for bumpers of vehicles or to improve the impact resistance of vehicle's coachwork.

According to the present invention, the terms “impact beam” refer to light weight structural parts of a car where impact resistance is of relevance. An ‘impact beam’ can be a front bumper, a rear bumper, one or two beams in the front door, one or two beams in the rear door, the A-pillar or A-post, the B-pillar or B-post, the C-pillar or C-post and the D-pillar or D-post or other elements of a vehicle that contribute to the impact protection of people of critical elements in the vehicle.

### BRIEF DESCRIPTION OF FIGURES IN THE DRAWINGS

The invention will now be described into more detail with reference to the accompanying drawings wherein

FIGS. 1 and 2 show different embodiments of impact beams comprising metal reinforcing fabric and only one layer of organosheet;

FIGS. 3 and 4 show different embodiments of impact beams comprising metal reinforcing fabric and two layers of organosheet;

FIG. 5 being schematically a view of a cross section of an impact beam as subject of the invention;

### MODE(S) FOR CARRYING OUT THE INVENTION

The reinforcing fabric itself is preferably made from metal although other materials are therefore not a prior excluded.

The metal reinforcing fabric can be understood as a woven, knitted or braided or welded or laminated structure. Different embodiments of a fabric according to the present invention can be considered. Most preferably steel wires or steel cords are used to provide the reinforcing fabric in the impact beam as subject of the invention.

A steel wire according to the invention was built as follows. Starting product is a steel wire rod. This steel wire rod has following steel composition: A minimum carbon content of 0.65%, a manganese content ranging from 0.40% to 0.70%, a silicon content ranging from 0.15% to 0.30%, a maximum sulphur content of 0.03%, a maximum phosphorus content of 0.30%, all percentages being percentages by weight. A typical steel cord composition for high-tensile steel cord has a minimum carbon content of around 0.80 weight %, e.g. 0.78-0.82 weight %. The steel rod is drawn in a number of consecutive steps until the required final diameter. The drawing steps may be interrupted by one or more heat treatment steps such as patenting. Then a steel cord according to the invention is made of a plurality of said steel wires above. The metal reinforcing fabric can be made of either of steel wires and steel cords or a mixture of them.

The layer of organosheet according to the invention comprises a polymer matrix sheet. This sheet is made out of polyamide- or polyolefin-based thermoplastic elastomers. The polymer matrix sheet may further comprise glass- or C-fibres, polymeric fibres and/or mineral fillers to reinforce the polymer matrix. Fibers can either be random, unidirectional, woven; stitched, chopped, or a combination of those.

A preferred example of organosheet is made from TEPEX® CETEX or CFRT material.

Examples of impact beams according to the invention:

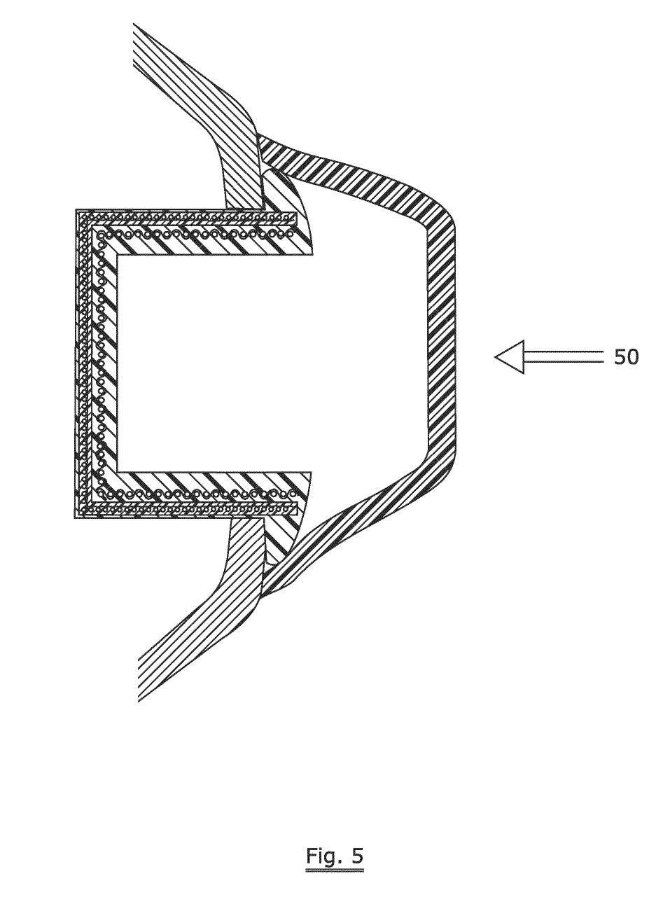

FIGS. 1 and 2 show different embodiments of impact beams comprising steel reinforcing fabric and only one layer of organosheet. The layer of organosheet is positioned between the steel fabric and the exterior surface of the impact beam. Such a layer of organosheet helps said steel fabric to avoid exposing to the air directly, which will take a high risk at corrosion. FIG. 1 illustrates impact beam 10 with steel fabric 12 and one layer of organosheet 14; FIG. 2 shows impact beam 20 with steel fabric 22 and one layer of organosheet 24. In impact beam 10, the steel fabric 12 and the layer of organosheet 14 are lying in the main volume while in impact beam 20, the steel fabric and the layer of organosheet are not only located in the main volume but also in the pair of legs of the impact beam, which may be used to fix the impact beam to other parts of the object to which it is to be mounted, but also contribute to the impact strength of the beam, whereas the main volume will absorb most of the impact energy provided by an impact in direction as indicated with arrow 50 in FIG. 5.

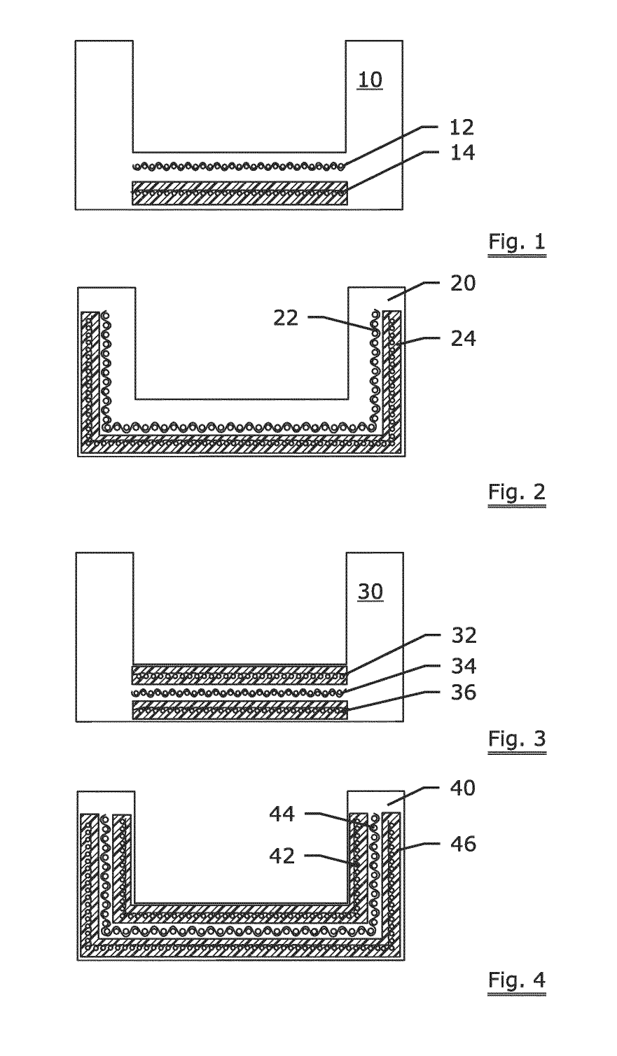

FIGS. 3 and 4 show different embodiments of impact beams comprising steel reinforcing fabric and two layers of organosheet. The first layer of organosheet is positioned between the steel fabric and the inner surface of the impact beam while the second layer of the organosheet is lying between the steel fabric and exterior surface of the impact beam. One can observe that such a structure of two layers of organosheet and the steel fabric looks like a ‘sandwich’. The first layer of organosheet may function as a further reinforced element in the impact beam while the second layer of organosheet still works as a ‘distance keeper’ as the first two embodiments. FIG. 3 shows an impact beam 30 with a first layer of organosheet 32 and the steel fabric 34 and the second layer of organosheet 36 while FIG. 4 illustrates an impact beam 40 with a first layer of organosheet 42 and the steel fabric 44 and the second layer of organosheet 46.

Turning now to a method to provide an impact beam as subject of the invention.

First a steel reinforcing fabric is provided comprising a plurality of steel cords. Also at least one layer of organosheet made from TEPEX® material is manufactured. When the thus formed steel reinforcing structure and one layer of organosheet are placed in an injection mould and thermoplastic material is injected, the thermoplastic material will not only enclose the steel reinforcing structure and the layer of organosheet but also form into the desired structure.

After this molding, the mold and the shaped impact beam are cooled to a temperature for which the polymer material is solidified. The impact beam may then be taken out of the mold and is ready for further processing, such as quality control or provision of additional openings.

An impact beam is so provided as shown in FIG. 5, which may be used as support for soft bumpers of vehicles.

1.-12. (canceled)

13. An impact beam comprising a polymer matrix and a reinforcing fabric, said impact beam further comprises at least one layer of polymer material, wherein said layer of polymer material is positioned between the reinforcing fabric and the exterior surface of the impact beam in order to keep the reinforcing fabric away from the exterior surface of the impact beam.

14. An impact beam as claimed in claim 13, wherein said impact beam comprises one layer of organosheet being positioned between the reinforcing fabric and the exterior surface of the impact beam.

15. An impact beam as claimed in claim 13, wherein said impact beam further comprises at least one layer of organosheet being positioned between the fabric and the inner surface of the impact beam.

16. An impact beam as claimed in claim 15, wherein said impact beam comprises a first layer and a second layer of organosheet, said first layer of organosheet being positioned between the fabric and the exterior surface of the impact beam and said second layer of organosheet being positioned between the fabric and the inner surface of the impact beam.

17. An impact beam as claimed in claim 13, wherein said one layer of polymer material is a continuous fiber reinforced material.

18. An impact beam as claimed in claim 14, wherein said layer of organosheet comprises a polymer matrix sheet.

19. An impact beam as claimed in claim 18, wherein said polymer matrix sheet is made out of polyamide- or polyolefin-based thermoplastic elastomers.

20. An impact beam as claimed in claim 18, wherein said polymer matrix sheet further comprises glass- or C-fibers, polymeric fibers and/or mineral fillers.

21. An impact beam as claimed in claim 13, wherein said reinforcing fabric is made out of steel alloy.

22. An impact beam as claimed in claim 21, wherein said metal reinforcing fabric is a woven, braided knitted, welded or laminated structure comprising steel cords.

23. An impact beam as claimed in claim 16, wherein said impact beam comprises several of said layers of organosheet being essentially parallel to each other.

24. Method for manufacturing an impact beam for a vehicle, the method comprising the steps of:
providing a reinforcing fabric;
providing one or more layers of organosheet;
placing the reinforcing fabric with the one or more layers of continuous fibre reinforced material (organosheet or uni directional tape or laminate) into an injection mold;
injecting polymer material to the whole of above for bringing thereof into the desired form;
cooling the impact beam.

25. Use of an impact beam as claimed in claim 13, for bumpers of vehicles or to improve the impact resistance of vehicle's coachwork.
